(19) United States
(12) Patent Application Publication
(10) Pub. No.: US 2016/0202569 A1
(43) Pub. Date: Jul. 14, 2016

(54) LIQUID CRYSTAL DISPLAY

(71) Applicant: Samsung Display Co., Ltd, Yongin-si (KR)

(72) Inventors: Se Hyun LEE, Seoul (KR); Cheol SHIN, Hwaseong-si (KR); Hak Sun CHANG, Yongin-si (KR); Ka Eun KIM, Yongin-si (KR); Ki Chul SHIN, Seongnam-si (KR)

(21) Appl. No.: 14/966,971

(22) Filed: Dec. 11, 2015

(30) Foreign Application Priority Data
Jan. 9, 2015 (KR) 10-2015-0003666

(51) Int. Cl. G02F 1/1343; G02F 1/1362; G02F 1/1368

(52) U.S. Cl. CPC G02F 1/134309; G02F 1/13439; G02F 1/1368; G02F 1/136286; G02F 2001/134345

(57) ABSTRACT

A liquid crystal display (LCD) may include: a lower display panel having a pixel electrode positioned therein, the pixel electrode including one or more pixel unit electrodes; an upper display panel having a common electrode positioned therein, the common electrode including one or more common unit electrodes; and a liquid crystal layer positioned between the lower display panel and the upper display panel. The pixel unit electrode may include a plate part and fine branches extending from the plate part, the common unit electrode may include a cross-shaped opening, and a vertical opening of the cross-shaped opening is completely covered by the plate part without extending to an edge of the polygonal shape of the plate part.

### CROSS-REFERENCE TO RELATED APPLICATION

This application claims priority to and the benefit of Korean Patent Application No. 10-2015-0003666 filed in the Korean Intellectual Property Office on Jan. 9, 2015, the entire content of which is incorporated herein by reference.

### BACKGROUND

(a) Field

The present disclosure relates to a liquid crystal display (LCD).

(b) Description of the Related Art

A liquid crystal display (LCD) is a type of flat panel display (FPD) that are widely used today. An LCD applies different potentials to a pixel electrode and a common electrode of an LCD panel having a liquid crystal layer formed between an upper panel and a lower panel, forms an electric field to change the arrangement of liquid crystal molecules, and displays an image by adjusting light transmittance through the arrangement of liquid crystal molecules.

The LCD is classified into a twisted nematic (TN) type, a vertical alignment (VA) type, a plane to line switching (PLS) type, and the like. Among them, the VA-type LCD includes liquid crystal molecules with their major axes oriented substantially perpendicular to the upper and lower panels, in the absence of electric field. In the VA-type LCD, a plurality of domains in which liquid crystal molecules are tilted in different directions may be formed in one pixel to implement a wide viewing angle.

In order to form the plurality of domains, a cut-out part such as a slit may be formed in the pixel electrode and/or the common electrode, and a fringe field may be formed between the edge of the cut-out part and the electrode facing the edge of the cut-out part.

The above information disclosed in this Background section is primarily for enhancement of understanding of the background of the inventive concept and does not form a prior art to a person of ordinary skill in the art.

### SUMMARY

The inventive concept has been made in an effort to provide a display device capable of improving a liquid crystal controllability and a response speed and enhancing display quality by controlling texture expression.

According to an exemplary embodiment, a liquid crystal display (LCD) may include: a lower display panel having a pixel electrode positioned therein, the pixel electrode including one or more pixel unit electrodes; an upper display panel having a common electrode positioned therein, the common electrode including one or more common unit electrodes; and a liquid crystal layer positioned between the lower display panel and the upper display panel. The pixel unit electrode may include a plate part and fine branches extending from the plate part, the common unit electrode may include a cross-shaped opening, and a vertical opening of the cross-shaped opening may be completely covered by the plate part without extending to an edge of the polygonal shape of the plate part.

The vertical opening may have a length of 28 μm or less from the center of the cross-shaped opening.

The cross-shaped opening may further include a horizontal opening, and the horizontal opening may meet a side of the pixel unit electrode.

The plate part may have a rhombus shape, and an angle between the vertical opening and one side of the plate part may range from 45 degrees to 50 degrees.

The centers of the plate part and the cross-shaped opening may coincide with each other.

The LCD may further include: a gate line and a data line crossing each other while being insulated from each other; and a thin film transistor connected to the gate line and the data line. The pixel electrode may include first and second subpixel electrodes, and each of the first and second subpixel electrodes may include the plurality of pixel unit electrodes.

Each of the first and second subpixel electrodes may include four pixel unit electrodes.

The first and second subpixel electrodes may be defined based on their connections to thin film transistors.

The cross-shaped opening may further include an extension part positioned at the center thereof, and the extension part and the plate part may have similar shapes.

The plurality of vertical openings may not be connected to each other.

The plurality of horizontal openings may be connected to each other

The first and second subpixel electrodes may have the same area.

The plate part may have a rhombus-ish shape.

According to the LCD, the liquid crystal controllability can be improved through the fringe field formed at the end of the pixel electrode. Thus, the response speed can be improved, and textures can be reduced.

### BRIEF DESCRIPTION OF THE DRAWINGS

FIG. 1 is a circuit diagram of one pixel according to an exemplary embodiment of the inventive concept.

FIG. 2 is a top plan view of one pixel according to the exemplary embodiment of the inventive concept.

FIG. 3 is a cross-sectional view taken along II-II line of FIG. 2.

FIG. 4A is a top plan view of a pixel unit electrode and a common unit electrode according to an exemplary embodiment of the present invention, and FIG. 4B is a top plan view of a pixel unit electrode and a common unit electrode according to another exemplary embodiment of the inventive concept.

FIGS. 5A, 5B, and 5C are images showing that liquid crystal is controlled according to exemplary embodiments of the inventive concept and a comparative example.

FIG. 6 is a graph illustrating transmittances of FIGS. 5A to 5C.

FIGS. 7A, 7B, 8A, 8B, 9A, and 9B are images showing that liquid crystal is controlled according to the exemplary embodiments of the inventive concepts and the comparative examples.

FIG. 10A to FIG. 10B are liquid crystal control images for the cross-section of a unit electrode.

### DETAILED DESCRIPTION OF THE EMBODIMENTS

The present inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may be present. In contrast, when an element is referred to as being “directly on” another element, there are no intervening elements present.

An LCD according to an exemplary embodiment will be described in detail with reference to the drawings.

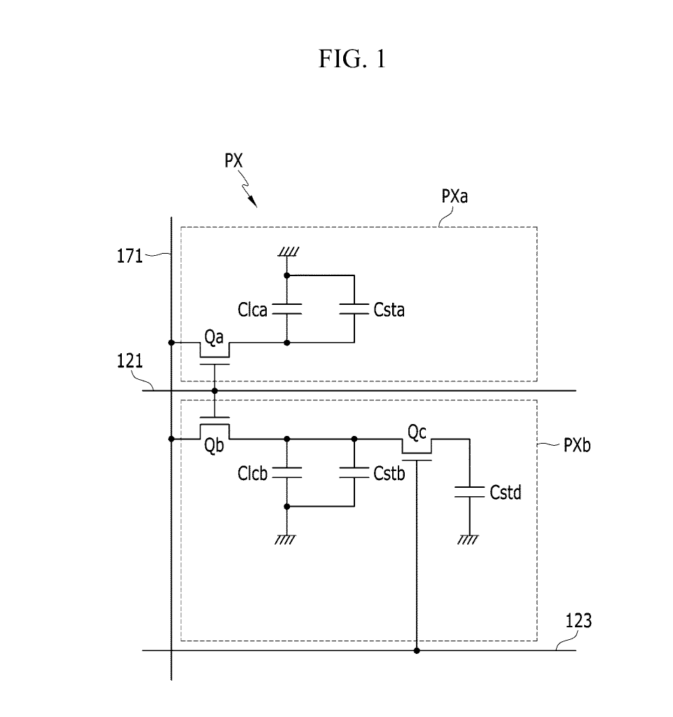

FIG. 1 is an equivalent circuit diagram of one pixel of an LCD according to an exemplary embodiment of the inventive concept.

Referring to FIG. 1, the LCD according to the exemplary embodiment may include signal lines and a pixel PX connected to the signal lines, the signal lines including a gate line 121, a reducing gate line 123, and a data line 171.

The pixel includes first and second subpixels PXa and PXb. The first subpixel PXa includes a first thin film transistor Qa, a first liquid crystal capacitor Clca, and a first storage capacitor Csta. The second subpixel PXb includes second and third thin film transistors Qb and Qc, a second liquid crystal capacitor Clcb, a second storage capacitor Cstb, and a reducing capacitor Cstd.

The first and second thin film transistors Qa and Qb may be connected to the gate line 121 and the data line 171, and the third thin film transistor Qc may be connected to the reducing gate line 123. The first thin film transistor Qs has a control terminal connected to the gate line 121, an input terminal connected to the data line 171, and an output terminal connected to the first liquid crystal capacitor Clca and the first storage capacitor Csta. The second thin film transistor Qb has a control terminal connected to the gate line 121, an input terminal connected to the data line 171, and an output terminal connected to the second liquid crystal capacitor Clcb and the second storage capacitor Cstb. The third thin film transistor Qc has a control terminal connected to the reducing gate line 123, an input terminal connected to the second liquid crystal capacitor Clcb, and an output terminal connected to the reducing capacitor Cstd. The reducing capacitor Cstd is connected to the output terminal of the third thin film transistor Qc and a common voltage.

The operation of such a pixel PX will be described as follows. First, when a gate-on voltage is applied to the gate line 121, the first and second thin film transistors Qa and Qb connected to the gate line 121 are turned on. Thus, the data voltage of the data line 171 is applied to the first and second liquid crystal capacitors Clca and Clcb through the first and second thin film transistors Qa and Qb, and the first and second liquid crystal capacitors Clca and Clcb are charged with a difference between the data voltage and the common voltage. At this time, a gate-off voltage may be applied to the reducing gate line 123.

Then, when a gate-off voltage is applied to the gate line 121 and simultaneously a gate-on voltage is applied to the reducing gate line 123, the first and second thin film transistors Qa and Qb connected to the gate line 121 are turned off, and the third thin film transistor Qc is turned on. Thus, the charge voltage of the second liquid crystal capacitor Clcb connected to the output terminal of the second thin film transistor Qb drops.

The LCD which is driven through frame inversion may set the charge voltage of the second liquid crystal capacitor Clcb to a lower voltage than the charge voltage of the first liquid crystal capacitor Clca at all times. As a result, the charge voltages of the first and second liquid crystal capacitors Clca and Clcb may be differently set to improve the side visibility of the LCD.

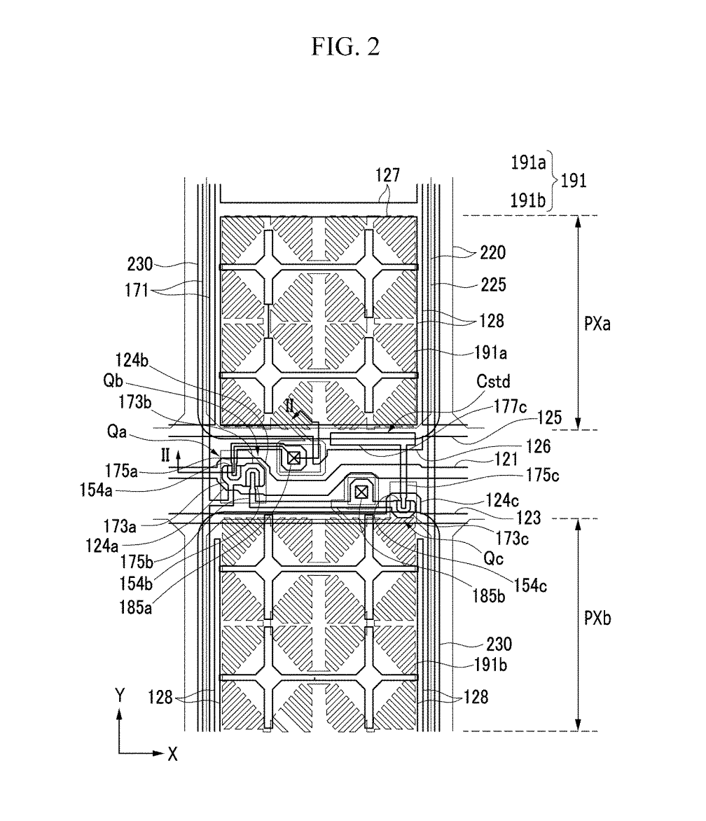

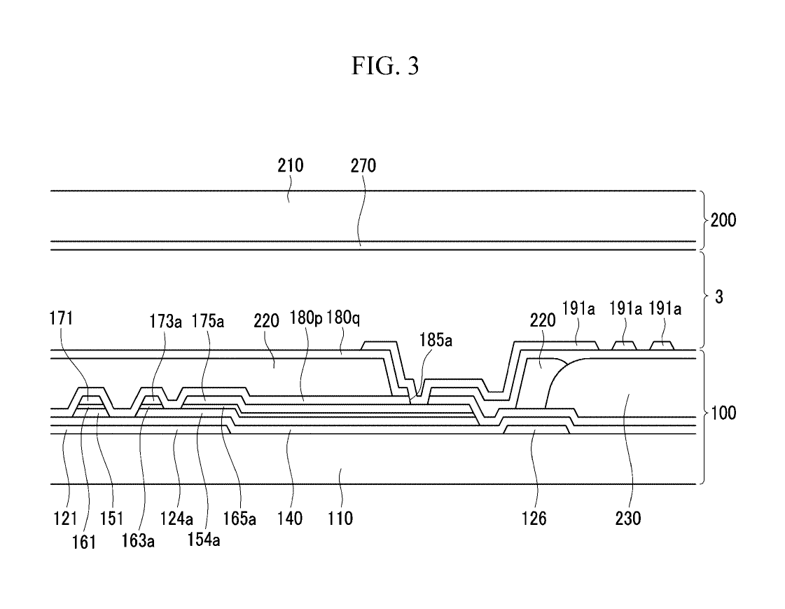

Hereafter, the LCD having the circuit structure illustrated in FIG. 1 will be described with reference to FIGS. 2 and 3. FIG. 2 is a top plan view of one pixel of the LCD according to the exemplary embodiment. FIG. 3 is a cross-sectional view of the LCD, taken along II-II line of FIG. 2. In the following descriptions, like reference numerals will be given to the same constituent elements as those of the above-described exemplary embodiment, and the descriptions of the same constituent elements will be omitted or simplified.

First, the LCD includes a lower display panel 100, an upper display panel 200, and a liquid crystal layer 3 positioned between the two display panels 100 and 200 facing each other.

First, the lower display panel 100 will be described. The lower display panel 100 includes a plurality of gate conductors positioned over a first insulation substrate 110 formed of a transparent insulating material such as glass, the plurality of gate conductors including a gate line 121, a reducing gate line 123, and a storage electrode line 125.

The gate line 121 and the reducing gate line 123 mainly extends in a horizontal direction and transmits a gate signal (also referred to as a scanning signal). The gate line 121 may include first and second gate electrodes 124a and 124b, and the reducing gate line 123 may include a third gate electrode 124c. The first gate electrode 124a and the second gate electrode 124b are connected to each other.

The storage electrode line 125 mainly extends in the horizontal direction and transmits a predetermined voltage such as a common voltage. The storage electrode line 125 may include a storage extension part 126, a pair of vertical openings 128 extending upward in parallel to the data line 171, and a horizontal opening 127 to connect the pair of vertical openings 128. However, the structure of the storage electrode line 125 is not limited thereto.

A gate insulating layer 140 is positioned over the gate conductors, and a semiconductor layer 151 is positioned over the gate insulating layer 140. The semiconductor layer 151 includes first and second semiconductor layers 154a and 154b extending toward the first and second gate electrodes 124a and 124b and connected to each other, and a third semiconductor layer 154c connected to the second semiconductor layer 154b.

An ohmic contact 161 may be positioned over the semiconductor layer 151, ohmic contacts 163a and 165a may be positioned over the first semiconductor layer 154a, and ohmic contacts (not illustrated) may be positioned over the second and third semiconductor layers 154b and 154c, respectively. Depending on an exemplary embodiment, the ohmic contacts 163a and 165a may be omitted.

Data conductors are positioned over the ohmic contact 163a and 165a, the data conductors including the data line 171, a first drain electrode 175a, a second drain electrode 175b, and a third drain electrode 175c. The data line 171 may include first and second source electrodes 173a and 173b extending toward the first and second gate electrodes 124a and 124b. Bar-shaped end parts of the first and second drain electrodes 175a and 175b may be partially surrounded by the first and second source electrodes 173a and 173b. A wide end part of the second drain electrode 175b may extend to form a third source electrode 173c which is bent in a U-shape. A wide end part 177c of the third drain electrode 175c overlaps the storage extension part 126 to form the reducing capacitor Cstd, and a bar-shaped end part of the third drain electrode 175c is partially surrounded by the third source electrode 173c.

The first gate electrode 124a, the first source electrode 173a, and the first drain electrode 175a form the first thin film transistor Qa with the first semiconductor layer 154a. The second gate electrode 124b, the second source electrode 173b, and the second drain electrode 175b form the second thin film transistor Qb with the second semiconductor layer 154b. The third gate electrode 124c, the third source electrode 173c, and the third drain electrode 175c may form the third thin film transistor Qc with the third semiconductor layer 154c.

A lower passivation layer 180p may be positioned over the data conductors 171, 175a, 175b, and 175c and the exposed semiconductor layers 154a, 154b, and 154c, and a color filter 230 and a light blocking member 220 may be positioned over the lower passivation layer 180p.

The light blocking member 220 may be formed in a region where the first thin film transistor Qa, the second thin film transistor Qb, and the third thin film transistor Qc are positioned. Depending on embodiments, one or more of the color filter 230 and the light blocking member 220 may be positioned in the upper display panel 200.

An upper passivation layer 180q is positioned over the color filter 230 and the light blocking member 220. This is in order to prevent impurities from flowing into the liquid crystal layer from the color filter 230.

The lower passivation layer 180p and the upper passivation layer 180q may have a plurality of contact holes 185a and 185b formed therein so as to expose the first and second drain electrodes 175a and 175b, respectively.

A pixel electrode 191 including first and second subpixel electrodes 191a and 191b is positioned over the upper passivation layer 180q. The pixel electrode 191 may be made of a transparent conductive material such as ITO or IZO or a reflective metal such as aluminum, silver, chrome, or an alloy thereof. The pixel electrode 191 may receive a data voltage through the thin film transistors Qa and Qb which are controlled by a gate signal.

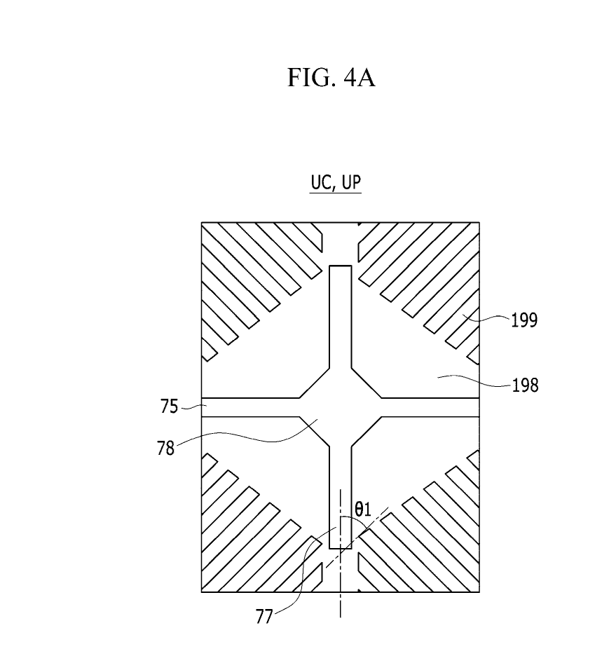

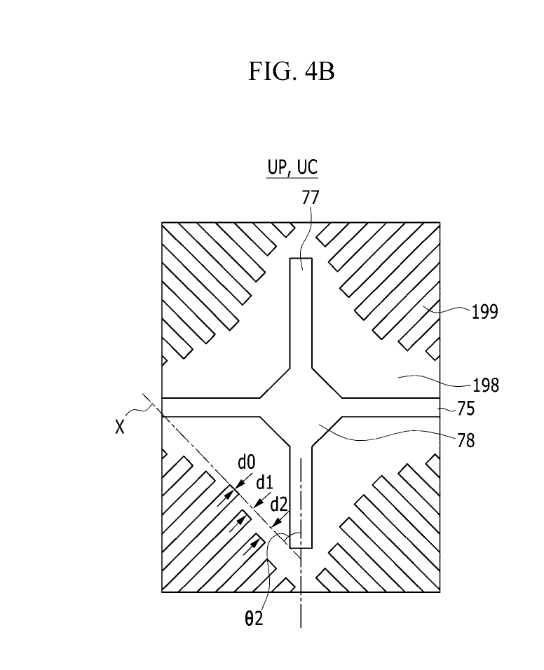

Each of the first and second subpixels 191a and 191b may include a plurality of pixel unit electrodes UP which will be described below with reference to FIG. 4A. For example, the first subpixel electrode 191a may include four pixel unit electrodes UP connected to each other, and the second subpixel electrode 191b may also include four pixel unit electrodes UP connected to each other (see FIG. 2).

The first subpixel electrode 191a may receive a data voltage from the first drain electrode 175a through the contact hole 185a, and the second subpixel electrode 191b may receive a data voltage from the second drain electrode 175b through the contact hole 185b.

Next, the upper display panel 200 will be described.

A common electrode 270 is positioned over a second insulation substrate 210 formed of a transparent insulating material such as glass.

The common electrode 270 may be formed of a transparent conductive material such as ITO or IZO. The common electrode 270 positioned in each of the subpixels PXa and PXb may include a plurality of common unit electrodes UC which will be described below with reference to FIG. 4A. For example, the common electrode 270 positioned in the first subpixel PXa may include four common unit electrodes UC connected to each other, and the common electrode 270 positioned in the second subpixel PXb may also include four common unit electrodes UC connected to each other.

Although the drawing illustrates that the light blocking member 220 and the color filter 230 are included in the lower display panel 100, one or more of the light blocking member 220 and the color filter 230 may be positioned between the second insulation substrate 210 and the common electrode 270.

The first subpixel electrode 191a and the common electrode 270 form the first liquid crystal capacitor Clca with the liquid crystal layer 3 therebetween, and the second subpixel electrode 191b and the common electrode 270 form the second liquid crystal capacitor Clcb with the liquid crystal layer 3 therebetween. The first and second liquid crystal capacitors Clca and Clcb maintain a voltage applied thereto even after the first and second thin film transistors Qa and Qb are turned off. Further, the first and second subpixel electrodes 191a and 191b may overlap the storage electrode line 125 so as to form the first and second storage capacitors Csta and Cstb.

The inventive concept can be applied to any exemplary embodiment in which the pixel electrode 191 for one pixel PX includes a plurality of pixel unit electrodes UP and the common electrode 270 for one pixel PX also includes a plurality of common unit electrodes UC.

The number of pixel unit electrodes UP or common unit electrodes UC included in one pixel PX may be differently set in consideration of a controllability for the arrangement direction of liquid crystal (hereafter, referred to as “liquid crystal controllability”) according to the structure and area of the pixel PX.

FIG. 4A is a top plan view of one unit electrode according to an exemplary embodiment, and FIG. 4B is a top plan view of one unit electrode according to another exemplary embodiment.

The electrode illustrated in FIG. 4A may correspond to the first subpixel electrode 191A including four pixel unit electrodes UP in the first subpixel PXa illustrated in FIG. 2 and the common electrode 270 including four common unit electrodes UC. Further, the electrode may correspond to the second subpixel electrode 191B including four pixel unit electrodes UP positioned in the second subpixel PXa and the common electrode 270 including four common unit electrodes UC.

The pixel electrode 191 includes a plurality of pixel unit electrodes UP connected to each other, and the common electrode 270 also includes a plurality of common unit electrodes UC connected to each other.

The pixel unit electrode UP has a substantially rectangular shape or square shape as a whole, and includes a plurality of fine branches extending in oblique directions from a plate part 198. The common unit electrode UC has a rectangular shape or square shape as a whole, and includes a cross-shaped opening 75 and 77 and an extension 78.

The plurality of pixel unit electrodes UP are connected to each other. The space between the pixel unit electrodes UP adjacent to each other in the extension direction of the data line (the y-direction) forms a horizontal gap, and the space between the pixel unit electrodes UP adjacent to each other in the extension direction of the gate line (the x direction) forms a vertical gap.

The plurality of common unit electrodes UC are connected to each other. The cross-shaped openings 75 and 77 of the common unit electrodes UC adjacent to other in the row direction or column direction may be connected to each other. At this time, the horizontal openings 75 of the cross-shape openings may be connected to each other. Depending on an exemplary embodiment, however, the adjacent vertical openings 77 are not connected to each other.

Referring to FIG. 4A, the pixel electrode 191 for one pixel PX according to the present exemplary embodiment includes the plate part 198 positioned in the center of the pixel unit electrode UP. For example, when the plate part 198 has a rhombus shape, each side of the plate part 198 may be set perpendicular to the direction in which the fine branches 199 extend.

As such, when each pixel unit electrode UP includes the plate part 198, the liquid crystal controllability may be improved through a fringe field formed at each side of the plate part 198. Thus, even after external pressure is removed, a stain caused by texture may be easily removed or suppressed from occurring.

Further, the plurality of sides forming the plate part 198 and the cross-shaped openings 75 and 77 included in the common unit electrode UC may form different angles. Specifically, the angle between the plurality of sides and the vertical opening 77 may be larger than the angle between the plurality of sides and the horizontal opening 75.

The angle θ1 between the plurality of sides and the vertical opening 77 may be set in the range of 45° to 60°. For example, the angle θ1 may be set to 50°. In order to effectively control liquid crystal, an asymmetrical structure in which the angle exceeds 45° may be provided. However, when the angle exceeds 50°, the transmittance may decrease. In this connection, the angle between the plurality of sides and the horizontal opening 75 may be set in the range of 40° to 45°. For example, the angle may be set to 40°.

That is, the liquid crystal controllability may be improved through the rhombus-shaped plate part 198 of which the diagonal length in the vertical direction is larger than the diagonal length in the horizontal direction. According to the exemplary embodiment of the present invention, the angle between the plurality of sides and the vertical opening 77 may be larger than the angle between the plurality of sides and the horizontal opening 75. Thus, the diagonal length in the horizontal direction may be larger than the diagonal length in the vertical direction. In this case, the viewing angle of the display device can be improved.

Further, the fine branches 199 of the pixel unit electrode UP may have a maximum length of approximately 53 μm. When the lengths of the fine branches 199 are reduced, the liquid crystal controllability can be increased by fringe fields formed at end parts of the fine branches 199, and the liquid crystal controllability around the horizontal gap 95 or vertical gap 97 can be increased. As the size of the plate part 198 increases within the limited pixel unit electrode UP, the lengths of the fine branches 199 decrease. Thus, the effect obtained by forming the plate part 198 and the effect obtained by reducing the lengths of the fine branches 199 may overlap each other to further reduce the occurrence of stain caused by external pressure.

The common electrode 270 for one pixel PX according to the present exemplary embodiment may include a common unit electrode UC, and the common unit electrode UC may include a cross-shaped opening 75 and 77 and an extension part 78 positioned in the center of the cross-shaped opening 75 and 77. For example, when the extension part 78 has a rhombus shape, each edge side of the extension 78 may form an oblique angle with respect to the extension direction of the cross-shaped opening. More specifically, the edge side of the extension 78 and the extension direction of the fine branches 199 may form a substantially right angle.

As such, when the common electrode 270 includes the extension part 78, a fringe field formed by an edge side of the extension part may have an effect around the horizontal gap or vertical gap, thereby increasing the liquid crystal controllability. Thus, even after external pressure is removed, stain caused by texture may be easily removed or suppressed from occurring.

The extension 78 may have the same plan shape as the plate part 198 of the pixel unit electrode UP. However, this is not a limitation of the inventive concept. Only the plate part 198 of the pixel unit electrode UP may have an asymmetrical rhombus shape or only the extension part 78 of the common unit electrode UC may have an asymmetrical rhombus shape. That is, it is not necessary for both the plate part and the extension part to have an asymmetrical structure.

The cross-shape opening includes a horizontal opening and a vertical opening 77. The horizontal opening 75 and the vertical opening 77 form a cross-shape while crossing each other at right angles. The center of the cross-shaped opening 75 and 77 positioned in the upper display panel may coincide with the center of the plate part 198 positioned in the lower display panel.

According to the exemplary embodiment, the cross-shaped opening 75 and 77 facing the plate part 198 of the pixel unit electrode UP may be formed in the common unit electrode UC, thereby strengthening the liquid crystal controllability in the arrangement direction of the liquid crystal 31.

The horizontal opening 75 is a line-shaped opening formed in the extension direction of the gate line, and may meet one side of the common unit electrode UC. Specifically, the horizontal opening 75 may be formed across the common unit electrode UC, and connected to the horizontal opening 75 of another adjacent common unit electrode.

The vertical opening 77 is a line-shaped opening formed in the extension direction of the data line (i.e., the y-direction), and does not reach one side of the common unit electrode. In other word, the vertical opening 77 does not meet one vertex of a polygon formed by the plate part. Specifically, the vertical opening 77 is formed across the extension direction of the data line, but formed so as not to meet one side of the common unit electrode UC. For example, the vertical opening 77 is formed to completely overlap the plate part 199 of the pixel unit electrode. That is, the length of the vertical opening 77 may be limited to the diagonal length of the plate part 198 in the vertical direction.

The vertical opening 77 according to the exemplary embodiment of the present invention may have a length of 28 μm or less from the center of the cross-shaped opening 75 and 77. When the vertical opening 77 is formed to have a larger length, the vertical opening 77 may meet one side of the common unit electrode UC. In this case, it is difficult to control liquid crystal in the vertical direction.

The adjacent vertical openings 77 may not be connected to each other. The horizontal opening 75 is formed to meet one side of the common unit electrode such that the adjacent horizontal openings 75 can be connected to each other. However, the vertical opening 75 is not formed to meet one side of the common unit electrode. Thus, adjacently positioned vertical openings 75 cannot be connected to each other.

According to such a unit electrode, liquid crystal may be controlled through one side of the pixel unit electrode UP, and controlled once again through the end part of the vertical opening 77 that does not coincide with one side of the pixel unit electrode but is positioned in the plate part 198. Since the liquid crystal is easily controlled, the response speed can be improved and texture can be easily controlled.

The plate part may have various planar shapes depending on the embodiment, and is not limited to the above-described shape. For example, referring to FIG. 4B, a unit electrode according to another exemplary embodiment will be described. The detailed descriptions of the same constituent elements are omitted herein.

First, a pixel unit electrode UP includes a rhombus-ish-shaped plate part 198 and a plurality of fine branches 199 extending in a substantially perpendicular direction from an imaginary straight side X (indicated by a dotted line) of the plate part 198.

The term “rhombus-ish shape” indicates a shape that is generally closer to a rhombus, including a modified-rhombus shape that has one or more sides that are not a straight line. The plate part 198 according to another exemplary embodiment does not have a regular rhombus but has the shape of a modified rhombus (i.e., a rhombus-ish shape). Thus, the term “imaginary side” is used to describe the modified shape. That is, suppose that a reference plate part has a regular rhombus shape, and one side thereof is set to an imaginary side X. Based on the imaginary side X, the shape of the pixel unit electrode UP including the plate part and the like according to the exemplary will be described.

The plate part 198 has a shape of which the distance from the imaginary straight side X (shown in FIG. 4B) to the edge increases closer to a vertex of the virtual rhombus. For example, the imaginary side X and the edge of the plate part 198 coincide with each other at the center d0 of the imaginary side X. However, as it gets away from the center d0 (in other words, it gets close to the vertex), the edge of the plate part 198 is located at a more remote position from the center of the pixel unit electrode UP than the imaginary side X. For example, the edge of the plate part 198 may be located at a distance d1 of 1 μm from the imaginary side X at a first point which is spaced from the center d0 of the side X by one fine branch 199 interposed therebetween. Further, the edge of the plate part 198 may be located at a distance d2 of 2 μm from the imaginary side X at a second point which is spaced from the first point d1 by one fine branch 199 interposed therebetween. Thus, the area of the plate part 198 increases more than when the plate part 198 has a rhombus shape, as in FIG. 4A. The plate part 198 has larger transmittance than the fine branches 199. Thus, as the area of the plate part 198 is increased, the transmittance also increases.

At two points separated by one fine branch part 199 interposed therebetween, the difference in distance from the imaginary side X to the edge of the plate part 198 may be set to approximately 2 μm or less. For example, the increment may be set in the range of approximately 1 μm to approximately 2 μm. When the increment is larger than 2 μm, a difference in liquid crystal orientation between slits may increase to cause a texture. However, the increment at which a texture can occur may differ depending on the width of the slit or the thickness of the fine branch 199.

The edge of the plate part 198 may get away from the imaginary side X in a stepwise manner as it gets away from the center d0. That is, the edge of the plate part 198 may be parallel to the imaginary side X at the respective points d1 and d2. In this case, the edge of the plate part 198 and the extension direction of the fine branches 199 may form a right angle which is favorable to the liquid crystal controllability.

The angle θ2 between the vertical diagonal line of the rhombus-ish shape of the plate part 198 and the imaginary side X may be set in the range of about 45° to about 50°.

The pixel unit electrode and the common unit electrode described above may be commonly positioned in the first and second subpixel electrodes. Specifically, since the first and second subpixel electrodes according to the exemplary embodiment of the present invention include four pixel unit electrode and common unit electrodes, respectively, the first and second subpixel electrodes have the same area. Thus, the pixel unit electrodes and the common unit electrodes that form the respective subpixel electrodes may have the same area. That is because, when the first and second subpixel electrodes include different numbers of unit electrodes, the first and second subpixel electrodes occupy different areas, and the unit electrodes forming the first and second subpixel electrodes have different areas even though the unit electrodes have the same shape.

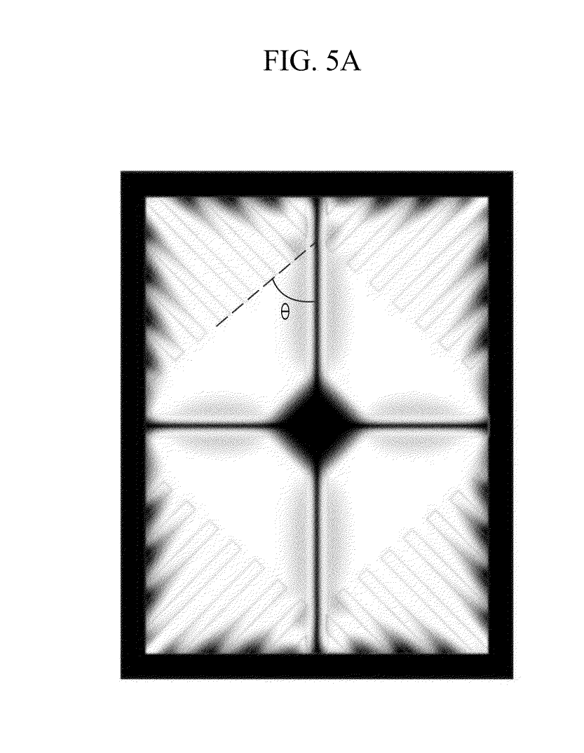

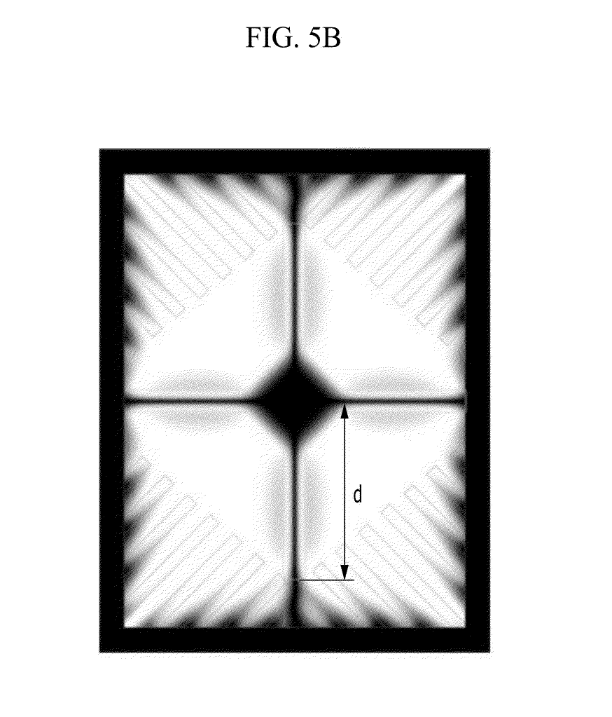

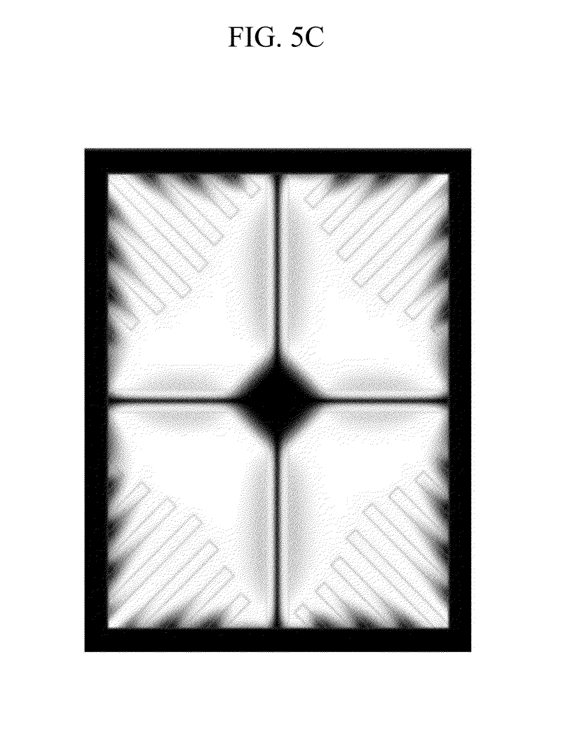

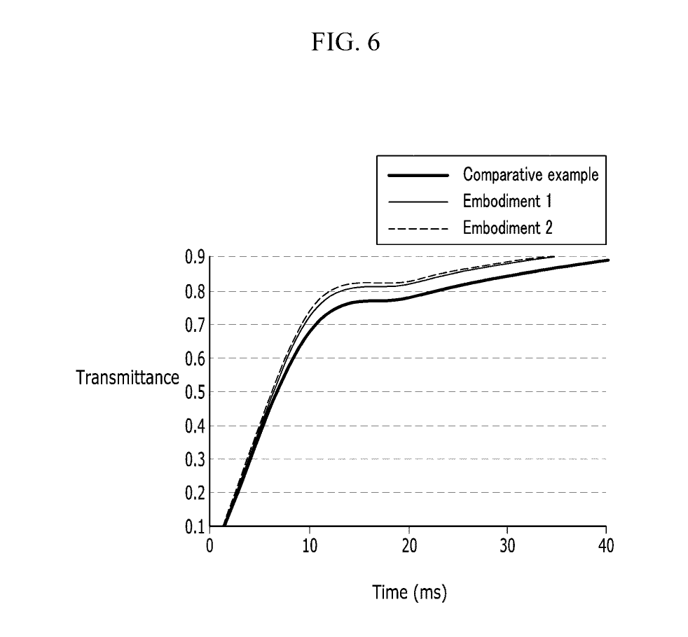

Hereafter, referring to FIGS. 5A to 9B, exemplary embodiments and a comparative example will be described. FIGS. 5A to 5C are images showing that liquid crystal is controlled according to the exemplary embodiments of the inventive concept and the comparative example, FIG. 6 is a graph illustrating transmittances of FIGS. 5A to 5C, and FIGS. 7A to 10B are images showing that liquid crystal is controlled according to the exemplary embodiments of the inventive concept and the comparative examples.

First, FIG. 5A (Exemplary Embodiment 1) illustrates the case in which the plate part of the pixel unit electrode according to the exemplary embodiment has an asymmetrical rhombus shape in which the angle between one side and the vertical opening θ is 50°, and FIG. 5B (Exemplary Embodiment 2) illustrates the case in which the length d of the vertical opening of the common unit electrode with the plate part is approximately 25 μm. The “θ” in FIG. 5A may be, but is not necessarily, θ1 or θ2 of FIGS. 4A and 4B. FIG. 5C (Comparative Example) illustrates the case in which the plate part includes corners having an angle of 90° and the vertical opening meets each side of the unit electrode.

FIG. 6 is a graph illustrating results obtained by observing response speeds of Exemplary Embodiments 1 and 2 and Comparative Example. Although not illustrated in the graph, experimental results show that Exemplary Embodiment 1 exhibits a transmittance of approximately 99.3%, Exemplary Embodiment 2 exhibits a transmittance of approximately 98%, and Comparative Example exhibits a transmittance of approximately 100%.

As described above, Comparative Example exhibits the highest transmittance. Referring to FIG. 6, however, Exemplary Embodiment 2 requires the shortest time until the transmittance reaches a predetermined value. The required time increases in order of Exemplary Embodiment 1 and Comparative Example. That is, according to the exemplary embodiments, the response speed can be improved. When the exemplary embodiments are observed for a long time, a transmittance loss may occur, but the exemplary embodiments can satisfy the transmittance required by existing LCDs.

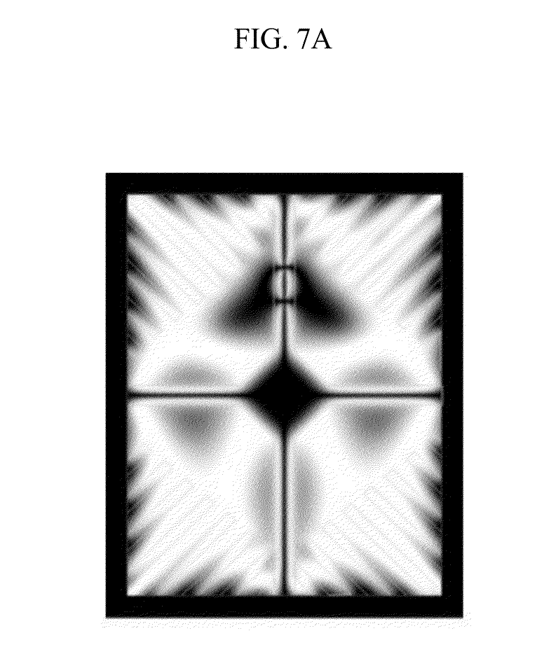

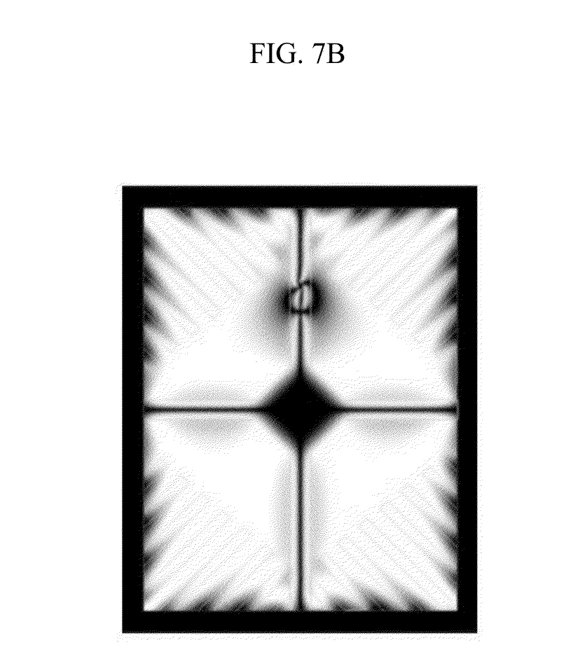

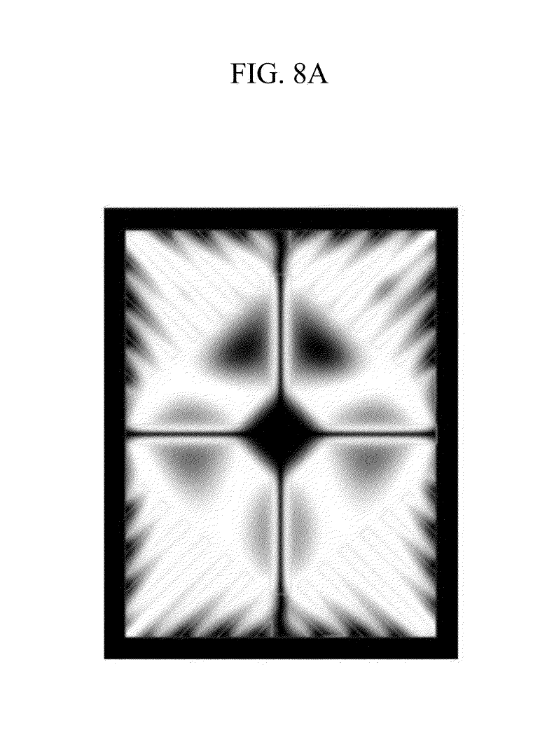

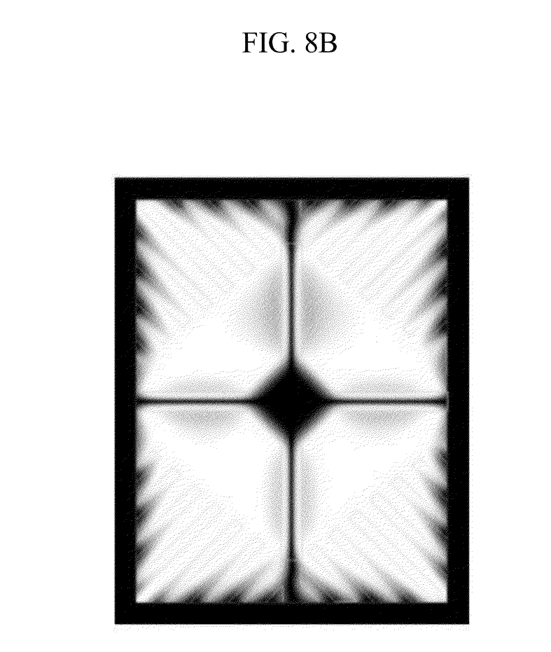

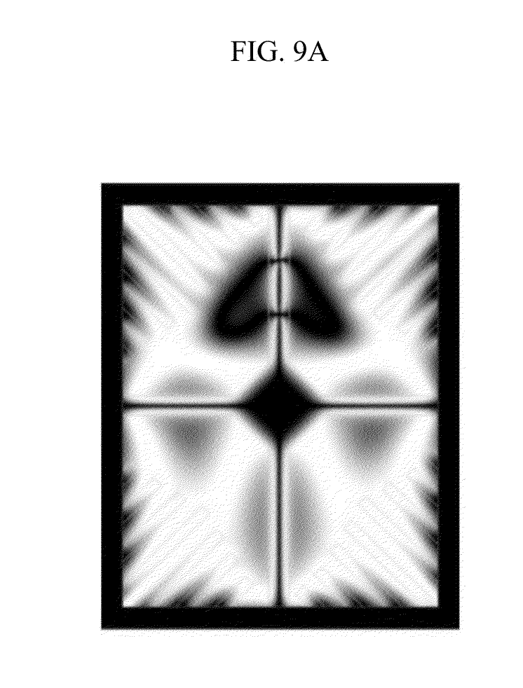

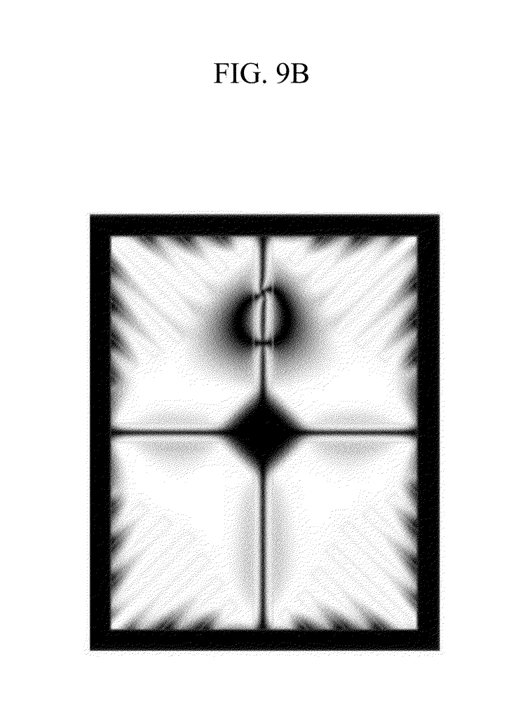

FIGS. 7A and 7B are images showing that textures occurred with time in Exemplary Embodiment 1, FIGS. 8A and 8B are images showing that textures occurred with time in Exemplary Embodiment 2, and FIGS. 9A and 9B are images showing that textures occurred with time in Comparative Example.

In Exemplary Embodiment 1 illustrated in FIGS. 7A and 7B, FIG. 7B was produced a period of time after FIG. 7A was produced. As shown, textures partially occurred around the vertical opening at the initial stage shown in FIG. 7A, but considerably disappeared with time.

In Exemplary Embodiment 2 illustrated in FIGS. 8A and 8B, almost no texture occurred at the initial stage depicted in FIG. 8A. However, as shown in FIG. 8B, the quality of the image was considerably improved after some time.

On the other hand, referring to FIGS. 9A and 9B, textures occurred around the vertical opening at the initial stage depicted in FIG. 9A, and remained very visible even after some time, as depicted in FIG. 9B. Compared to FIG. 7B, the textures having a considerably large size are continuously observed. This is because, since the vertical opening has a larger length in the Comparative Example than in the exemplary embodiments, the controllability for liquid crystal molecules positioned around the vertical opening was compromised.

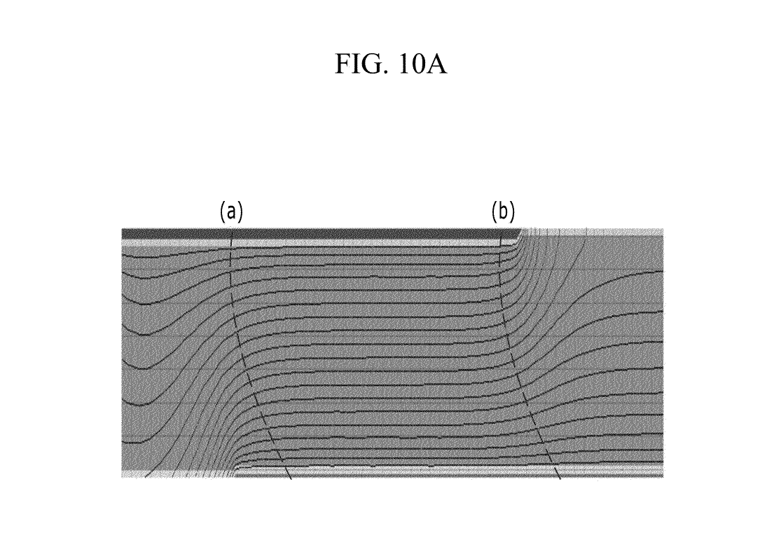

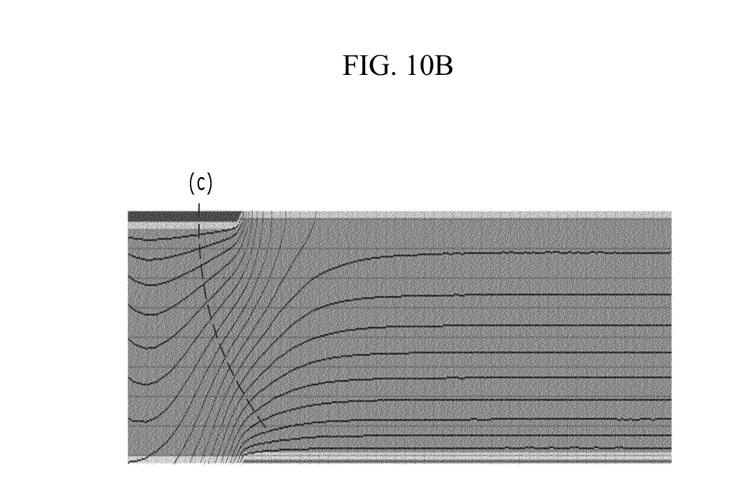

FIG. 10A is a liquid crystal control image for the cross-section of Exemplary Embodiment 2, and FIG. 10B is a liquid crystal control image for the cross-section of Comparative Example. In Exemplary Embodiment 2 of FIG. 10A, liquid crystal can be controlled (a) by the fringe field formed at the upper side of the pixel unit electrode, and then controlled (b) once again by the fringe field formed at the end of the vertical opening in the common unit electrode. Thus, as illustrated in FIG. 10A, the liquid crystal can be controlled across the predetermined length of the cross-section.

On the other hand, when the end of the vertical opening and the upper side of the pixel unit electrode coincide with each other in Comparative Example of FIG. 10B, textures may easily occur because liquid crystal is not separately controlled after the liquid crystal is controlled (c) once at the end of the vertical opening and the upper side of the pixel unit electrode.

When the angle of the plate part is changed or the length of the vertical opening is reduced according to the exemplary embodiment, the liquid crystal controllability can be improved through the fringe field effect of the pixel electrode and common electrode. Thus, the response speed can be improved, and the occurrence of textures can be prevented.

While this inventive concept has been described in connection with what is presently considered to be practical exemplary embodiments, it is to be understood that the inventive concept is not limited to the disclosed embodiments. On the contrary, the inventive concept is intended to cover various modifications and equivalent arrangements included within the spirit and scope of the appended claims.

<Description of symbols>

| | |
|---|---|
| 100: Lower display panel | 121: Gate line |
| 124a, 124b, 124c: Gate electrode | 125: Storage electrode |
| line | |
| 126: Storage extension part | 140: Gate insulating layer |
| 151, 154a, 154b, 154c: | 161, 163a, 165a: Ohmic contact |
| Semiconductor layer | |
| 171: Data line | 173a, 173b, 173c: Source electrode |
| 175a, 175b, 175c: Drain electrode | 180p, 180q: Passivation layer |
| 185a, 185b: Contact hole | 191: Pixel electrode |
| 191a: First subpixel electrode | 191b: Second subpixel electrode |
| 192: Connection part | 198: Plate part |
| 199: Fine branch | 200: Upper display panel |
| 210: Upper substrate | 220: Light blocking member |
| 270: Common electrode | 3: Liquid crystal layer |
| UC: Common unit electrode | UP: Pixel unit electrode |

What is claimed is:

1. A liquid crystal display (LCD) comprising:
a lower display panel having a pixel electrode positioned therein, the pixel electrode including one or more pixel unit electrodes;
an upper display panel having a common electrode positioned therein, the common electrode including one or more common unit electrodes; and
a liquid crystal layer positioned between the lower display panel and the upper display panel,
wherein the pixel unit electrode comprises a plate part and fine branches extending from the plate part,
the common unit electrode comprises a cross-shaped opening, and
a vertical opening of the cross-shaped opening is completely covered by the plate part without extending to an edge of the polygonal shape of the plate part.

2. The LCD of claim 1, wherein:
the vertical opening has a length of 28 μm or less from the center of the cross-shaped opening.

3. The LCD of claim 1, wherein:
the cross-shaped opening further comprises a horizontal opening, and
the horizontal opening coincides with ends of the fine branches.

4. The LCD of claim 1, wherein:
the plate part has a rhombus shape, and
an angle between the vertical opening and one side of the plate part ranges from 45 degrees to 50 degrees.

5. The LCD of claim 1, wherein:
the centers of the plate part and the cross-shaped opening coincide with each other.

6. The LCD of claim 1, further comprising:
a gate line and a data line crossing each other while being insulated from each other; and
a thin film transistor connected to the gate line and the data line,
wherein the pixel electrode comprises first and second subpixel electrodes, and
each of the first and second subpixel electrodes comprises the plurality of pixel unit electrodes.

7. The LCD of claim 6, wherein:
each of the first and second subpixel electrodes comprises four pixel unit electrodes.

8. The LCD of claim 6, wherein:
the first and second subpixel electrodes are defined based on their connections to thin film transistors.

9. The LCD of claim 1, wherein:
the cross-shaped opening further comprises an extension part positioned at the center thereof, and
the extension part and the plate part have the same shape.

10. The LCD of claim 3, wherein:
the plurality of vertical openings are not connected to each other.

11. The LCD of claim 3, wherein:
the plurality of horizontal openings are connected to each other.

12. The LCD of claim 6, wherein:
the first and second subpixels have the same area.

13. The LCD of claim 1, wherein:
the plate part has a rhombus-ish shape.
